(19) United States
(12) Patent Application Publication
(10) Pub. No.: US 2005/0183077 A1
(43) Pub. Date: Aug. 18, 2005

(54) System and method for JIT memory footprint improvement for embedded java devices

(75) Inventors: Philip Lee Langdale, Austin, TX (US); Mikael Orn, Phoenix, AZ (US); James Patrick Robbins, Austin, TX (US); William J. Tracey, Round Rock, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation, Armonk, NY (US)

(21) Appl. No.: 10/777,908

(22) Filed: Feb. 12, 2004

(51) Int. Cl. G06F 9/45

(52) U.S. Cl. 717/148

(57) ABSTRACT

A system and method for reclaiming memory occupied by compiled code resulting from a Just-in-Time (JIT) compiler is provided. An address space used to store code resulting from a JIT compiler is memory mapped using a special filesystem. A map is maintained identify method name and corresponding JIT pages. When the memory manager needs more space, it requests that the special filesystem write the data from memory back to nonvolatile storage. The special filesystem acts as if the data was written. When the code is subsequently called, a page fault and an invalid operation exception occur and are handled. The data in the map is used to recompile the method to the same address space and the faulting instruction is re-executed.

### BACKGROUND OF THE INVENTION

1. Technical Field

The present invention relates in general to a system and method for improving memory usage for Just-in-Time (JIT) compiled programs. More particularly, the present invention relates to a system and method for using a special filesystem and an exception handler to allow memory occupied by JITed code to be reclaimed by the operating system and automatically regenerated when subsequently needed.

2. Description of the Related Art

Pervasive computing devices are available to perform a wide variety of tasks in today's business arena. Semiconductor technology has enabled devices such as mobile telephones and personal digital assistants (PDAs) to perform tasks that, until recently, were reserved for more traditional computers.

These pervasive computing devices include more powerful operating systems. Some of these operating systems support middleware applications, such as “virtual machines” that are adapted to run platform-neutral applications. A popular example of a virtual machine is the Java Virtual Machine (JVM). Programs written to execute using a JVM will operate on any JVM regardless of the underlying hardware and operating system used by the computing device. Underlying operating systems include Microsoft's Windows™ based operating systems as well as Unix-based operating systems such as IBM's AIX operating system and the Linux operating system.

One challenge encountered with pervasive computing devices is that they often have considerably less storage, memory, and CPU horsepower than desktop computer systems. However, organizations and other enterprises often desire fairly sophisticated applications to run on these devices. These applications can be the same applications as those running on the organization's desktop computers, while sometimes applications are modified or customized to operate on the pervasive computing device.

Dynamic translation, also known as Just-in-time compilation (JIT), is a virtual machine implementation approach, used to speed up execution of bytecode computer programs. To execute a program unit such as a method or a function, the virtual machine compiles its bytecodes into (hardware) machine code. As used herein, “program units” are referred to as “methods” unless otherwise noted. The translated code is also placed in a cache, so that next time that method's machine code can be executed immediately, without repeating the translation.

A challenge encountered in pervasive computing environments, however, is that JITed code cannot be discarded when the operating system needs to find additional memory. In a typical implementation of an operating system, such as Linux, on a pervasive computing device there is no swap capability. However, in these environments, there is the ability to discard code pages and reload them when a subsequent page fault occurs.

What is needed, therefore, is a system and method that allows the operating system to discard memory pages that contain JITed code. What is further needed is a system and memory that rebuilds the JITed code when it is subsequently needed.

### SUMMARY

It has been discovered that an address space used to store code resulting from a JIT compiler can be memory mapped using a special filesystem. The JIT pages are memory mapped to a JIT cache that is maintained by the special JIT filesystem. A mapping is maintained to identify the method name that corresponds to JIT pages.

The JIT filesystem is a special filesystem that memory maps the compiled JIT program to a cache within the JIT filesystem. As used herein, the terms “JIT filesystem” and “special filesystem” are used interchangeably to refer to this filesystem. When the memory manager running in the operating system (i.e., the kernel) needs more space, it determines that one or more of the memory mapped JIT pages can be reclaimed and requests that the special filesystem write the data from memory back to the JIT filesystem.

Acting as a special filesystem, the JIT filesystem does not actually write the data from the memory mapped JIT pages back to the JIT cache. Instead, the JIT filesystem simply replies that the operation completed successfully whereupon the operating system reclaims the pages. When a branch is subsequently made to an instruction that existed in one of the reclaimed pages, a page fault occurs. The operating system responds to the page fault by requesting that the special filesystem reload the page(s). However, since the special filesystem never wrote the page(s) to nonvolatile storage in the first place, the special filesystem does not have the code that belongs in the page(s). Instead, the special filesystem initializes the pages and writes an invalid operation code (opcode) to the initialized pages.

The special filesystem then returns a response to the operating system indicating that the pages were successfully loaded. The operating system then tries to re-execute the instruction that caused the page fault. Now, however, the system encounters an invalid opcode, causing a special error handler to be called to handle the invalid opcode.

The error handler uses mapping data to determine which method used to reside at the discarded page(s), recompiles the method (using the JIT compiler), and stores the recompiled code back to the same memory mapped JIT pages that stored the original compiled code (i.e., the error handler recreates the compiled code and stores it in the same location that it occupied before the pages were discarded). The address that originally caused the page fault is branched to once again, however this time the recompiled code occupies the pages and the instructions execute successfully.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a high level flowchart showing how virtual machine code can be compiled or interpreted with each type of code being effectively paged in order to manage memory;

FIG. 2 is a memory map of a Unix-type operating system which includes memory mapped JITed pages as well as a memory mapped Java Executable Image (JXE) file;

FIG. 3 is a diagram showing memory mapping, page reads, and memory reclamation of a Java Executable Image (JXE) file;

FIG. 4 is a flowchart showing the steps taken to load a Java Executable Image (JXE) file, mapping the file to an allocated memory area, and loading pages from the JXE file into the allocated memory when a page fault occurs;

FIG. 5 is a high level flowchart showing a virtual machine being initialized and executing programs, some of which are compiled using a Just-in-Time (JIT) compiler;

FIG. 6 is a flowchart showing steps taken by the JIT compiler when a Java program running by the Java Virtual Machine (JVM) is compiled;

FIG. 7 is a flowchart showing steps taken to increase the amount of address space used to store compiled programs resulting from the JIT compiler;

FIG. 8 is a flowchart showing the interaction between the operating system's memory manager (performing memory reclamation tasks) and a special filesystem that is used in conjunction with JITed code;

FIG. 9 is a flowchart showing interaction between the operating system's memory manager (performing page fault handling), the special filesystem that is used in conjunction with JITed code, and an error handler that is used to reload code that was removed from memory during a prior memory reclamation task; and

FIG. 10 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

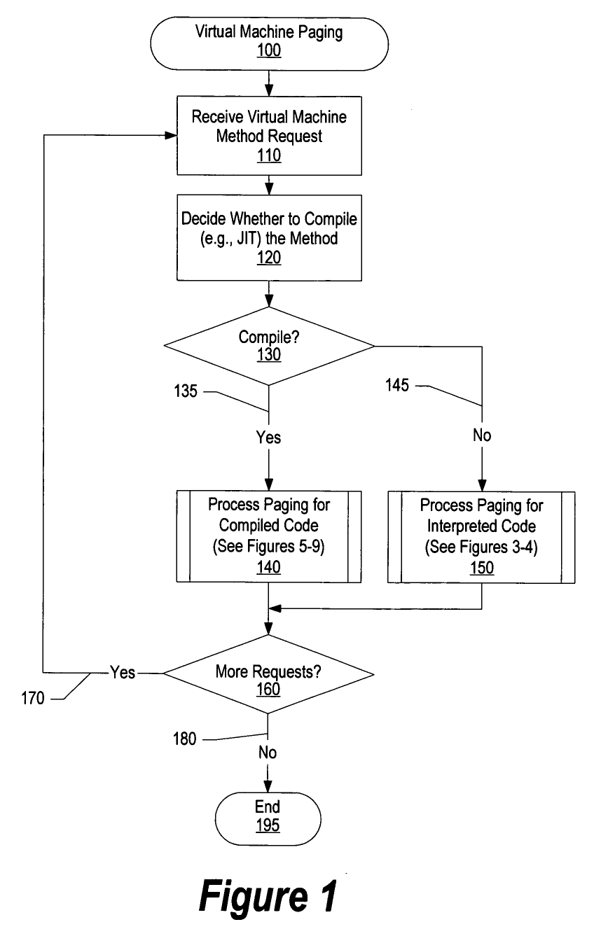

FIG. 1 is a high level flowchart showing how virtual machine code can be compiled or interpreted with each type of code being effectively paged in order to manage memory. Processing commences at 100 whereupon, at step 110, the virtual machine, such as a Java Virtual Machine (JVM), receives a request to execute a virtual machine application, such as an applet or other method that includes bytecode.

At step 120, the virtual machine decides whether to compile the requested method, using a Just-in-Time (JIT) compiler, or whether to execute the method by interpreting the bytecode that comprises the method. This decision is based upon a variety of factors, such as how often the method is requested.

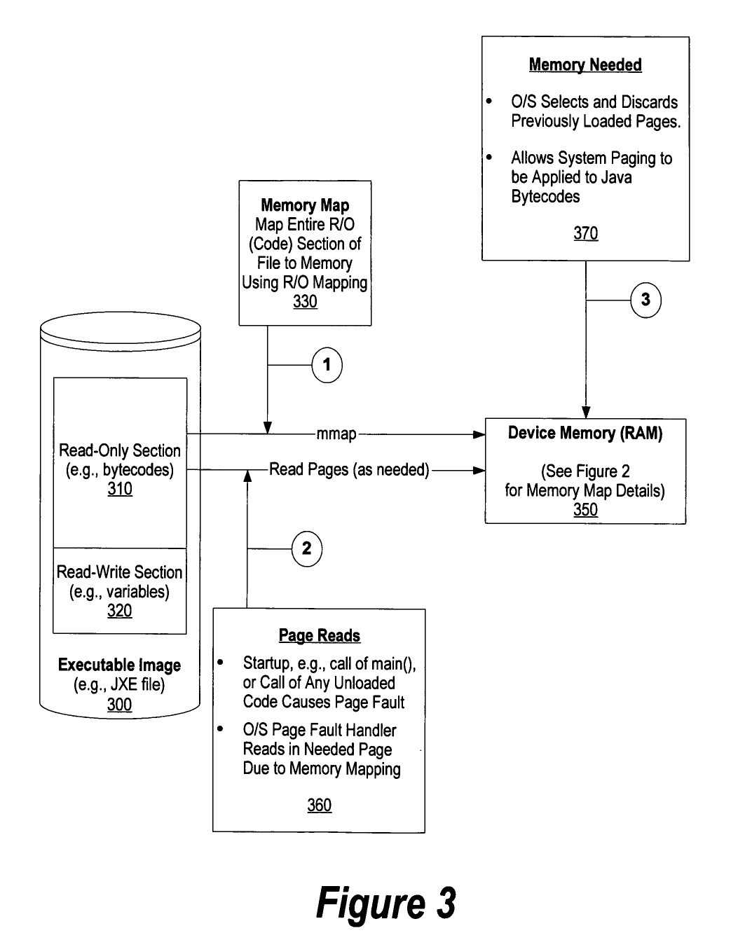

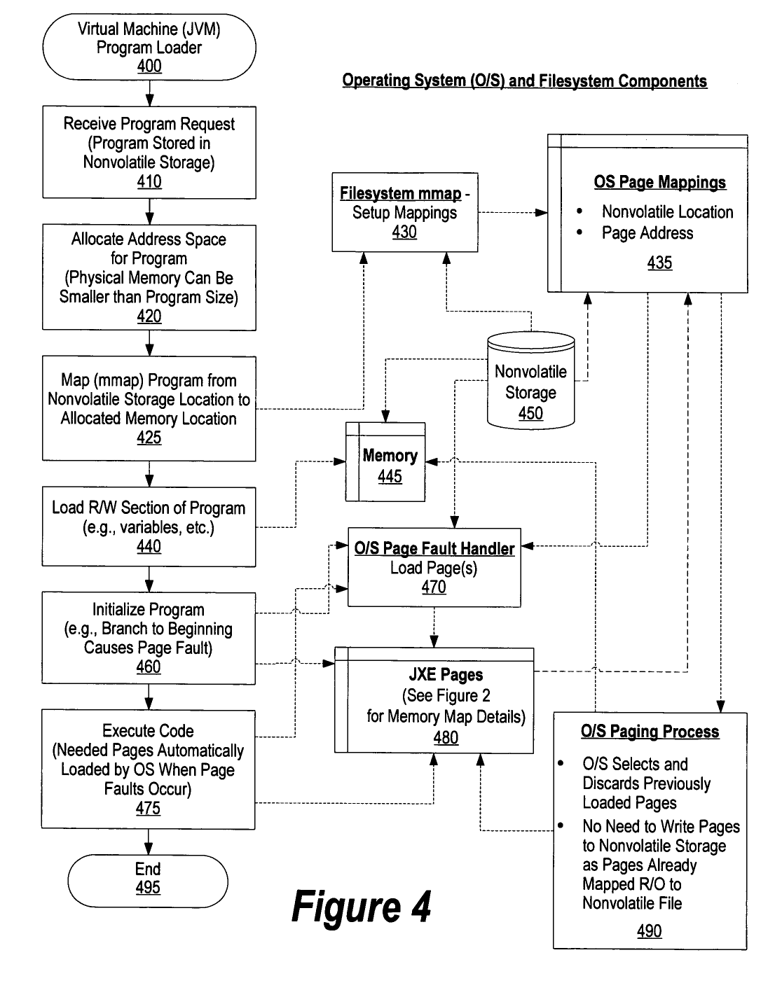

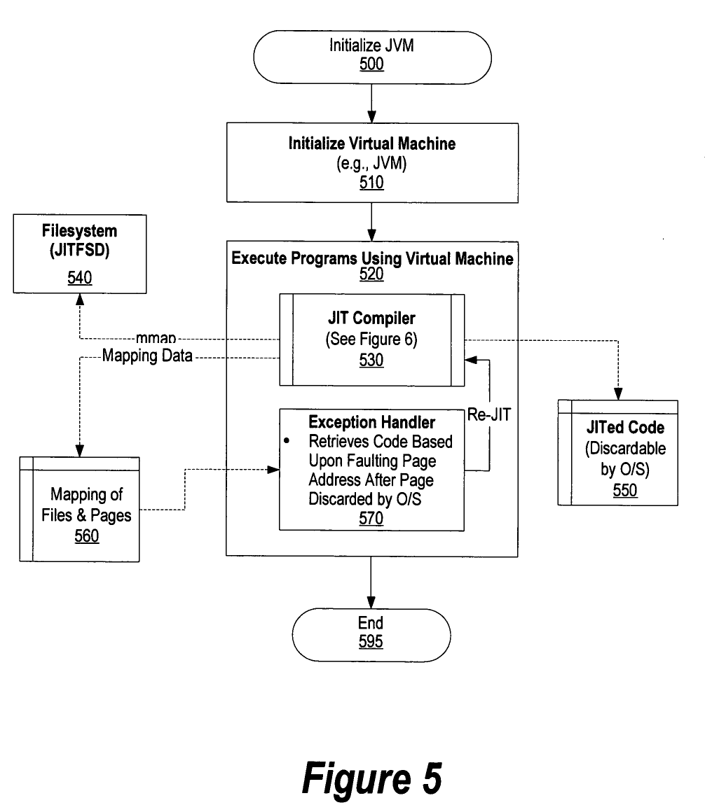

A determination is made as to whether to compile the method using the virtual machine's Just-in-Time compiler (decision 130). If the method is to be compiled using the virtual machine's JIT compiler, decision 130 branches to “yes” branch 135 whereupon a paging process is performed to keep track of the JITed code pages and recompile the JITed code if the JITed code pages are reclaimed by the operating system (predefined process 140, see FIGS. 5-9 and corresponding text for processing details). On the other hand, if the requested method is being interpreted rather than compiled, decision 130 branches to “no” branch 145 whereupon a paging process is performed that memory maps the interpretable code to a nonvolatile storage location and reads in pages from the nonvolatile storage location when needed (predefined process 150, see FIGS. 3-4 and corresponding text for processing details).

A determination is made as to whether there are more method requests for the virtual machine to process (decision 160). If there are more requests, decision 160 branches to “yes” branch 170 whereupon processing loops back to receive and process the next request. This looping continues until there are no more requests to process (i.e., the computer system and/or the virtual machine is shutdown), at which point decision 160 branches to “no” branch 180 and processing ends at 195.

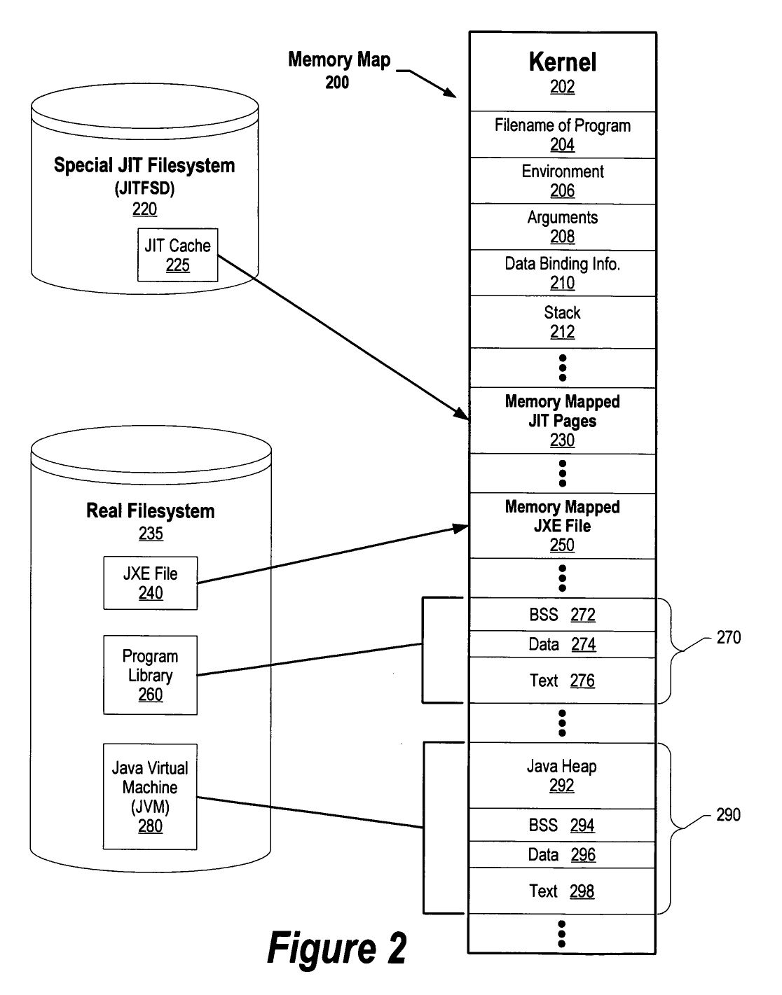

FIG. 2 is a memory map of a Unix-type operating system which includes memory mapped JITed (compiled) pages as well as a memory mapped interpretable Java Executable Image (JXE) file. Memory map 200 includes a variety of processes and data. Kernel 202 is the kernel of the operating system. Filename of program 204 is a memory location in which the name of the program is stored. Environment 206 includes environment settings for the program. Arguments 208 are parameters that are passed to the program. Data binding information 210 is information used to bind data that is read or written by the program. Stack 212 is a FIFO memory that stores the program stack for the program.

Memory mapped JIT pages 230 are memory pages used by the JIT compiler to store compiled programs. As shown, the JIT pages are memory mapped to JIT cache 225 that is maintained by special JIT filesystem 220 (JIT filesystem driver, or JITFSD). A mapping is maintained to identify the method name that corresponds to JIT pages. The JIT filesystem is a limited filesystem that memory maps the compiled JIT program to a cache within the JIT filesystem. When the memory manager running in the operating system (i.e., the kernel) needs more space, it determines that one or more of the memory mapped JIT pages can be reclaimed and requests that the JIT filesystem write the data from memory back to the JIT filesystem. Acting as a special filesystem, the JIT filesystem does not actually write the data from the memory mapped JIT pages back to the JIT cache. Instead, the JIT filesystem simply replies that the operation completed successfully whereupon the operating system reclaims the pages. When a branch is subsequently made to an instruction that existed in one of the reclaimed pages, a page fault occurs. The operating system responds to the page fault by requesting that the special JIT filesystem reload the page(s). However, since the special filesystem never wrote the page(s) to nonvolatile storage in the first place, the special filesystem does not have the code that belongs in the page(s). Instead, the special filesystem initializes the pages and writes an invalid operation code (opcode) to the initialized pages. In one embodiment, the invalid opcode is x′00′ and is written to the entire page (or pages). In this manner, regardless of the instruction being branched to on the page, the instruction is always the same invalid (i.e., x′00′) instruction. The special filesystem then returns a response to the operating system indicating that the page(s) was/were successfully loaded. The operating system then tries to re-execute the instruction that caused the page fault. Now, however, the system encounters an invalid opcode, causing a special error handler to be called to handle the invalid opcode. The error handler uses mapping data to determine which method used to reside at the discarded page(s) and recompiles the method (using the JIT compiler) and stores the recompiled code back to the same memory mapped JIT pages that stored the original compiled code (i.e., the error handler recreates the compiled code and stores it in the same location that it occupied before the pages were discarded). The address that originally caused the page fault is branched to once again, however this time the recompiled code occupies the pages and the instructions execute successfully.

The read-only portion of a Java Executable Image (JXE) file 240 stored in nonvolatile storage managed by real filesystem 235 is memory mapped “read-only” to memory address 250 in memory map 200. Because the file is mapped “read-only,” the operating system is free to reclaim the memory space (250) in which the JXE resides in the memory map as no dynamic data, such as variables, are stored in memory address range 250. When code within discarded pages is called, the operating system's page fault handler reads the needed page from nonvolatile storage location 240 to which the memory page is mapped.

Program library 260, such as a C Program Library, is stored in nonvolatile storage managed by filesystem 235. The library is stored to memory region 270 in three memory areas. BSS (Block Started by Symbol) memory area 272 includes uninitialized data segments produced by a linker operating in a Unix-type operating environment. An uninitialized data segment has a name and a size but no value (until a value is set by the program). Data memory area 274 includes initialized data, such as variables, that have a name, size and a value. Text memory area 276 includes the program code (i.e., the instructions used to perform the library functions).

Java virtual machine 280 is a program that is also managed by filesystem 235. The program is stored to memory region 290 in four memory areas. Java heap 292 is a memory region used to store objects managed by the Java Virtual Machine (JVM) program. BSS memory area 294 stores uninitialized data segments, data memory area 296 stores initialized data, and text memory area 298 stores the program code for the JVM program.

FIG. 3 is a diagram showing memory mapping, page reads, and memory reclamation of a Java Executable Image (JXE) file. Executable image (JXE file) 300 is stored in nonvolatile storage and includes two sections. The first section is read-only section 310 that includes static instructions such as Java bytecodes. The second section is read-write section 320 that includes dynamic data, such as variables, that need to be both read and written.

The first process (step 330) memory maps the read-only section of the executable image (i.e., the bytecodes) to memory location 350 (see FIG. 2, memory mapped location 240, and corresponding text for further detail). Read-only mapping is used so that the operating system's paging process will be able to discard pages without first needing to request that the pages be swapped out to nonvolatile storage.

The second process (step 360) occurs when instructions in any of the memory mapped pages are called before the page is loaded into memory. When the program is started, the initial instruction of the code is called. Because that code has not yet been written to device RAM 350, a page fault occurs. The operating system's page fault handler uses the memory mapping that was performed in the first step in order to fetch the needed page(s) and write the page(s) to memory 350.

The third process (step 370) only occurs if the operating system needs to reclaim memory. When the operating system needs additional memory, a paging process is used to identify least-recently used pages from memory 350. If the identified least-recently used pages are pages that have been memory mapped to read-only section 310 of the Java executable, then the pages are simply discarded and the memory reused. The pages are not written back to nonvolatile storage because the pages have been memory mapped (mmap-ed) to read-only section 310 as read-only pages, indicating that the pages are static and can be discarded without losing data that already exists on the nonvolatile storage device.

FIG. 4 is a flowchart showing the steps taken to load a Java Executable Image (JXE) file, mapping the file to an allocated memory area, and loading pages from the JXE file into the allocated memory when a page fault occurs. The processing of the virtual machine program loader, such as the JVM program loader, commences at 400. At step 410, the program loader receives a request to load a program that is currently stored in nonvolatile storage 450.

At step 420, the loader allocates address space for the program being loaded. The actual amount of physical memory allocated can be smaller than the program size as pages of the program will be read into the allocated address space when needed. The loader memory maps (mmaps) the read-only section of the program stored on nonvolatile storage to the allocated address space at step 425 and indicates that the mapping is read-only mapping. The filesystem being used by the operating system performs the memory mapping (step 430) and stores nonvolatile locations and corresponding page addresses in operating system page mapping table 435. At step 440, the loader also loads the read/write section of the program into memory 445. The read/write section of the program is not memory mapped because this section includes dynamic elements, such as variables, that would need to be swapped (i.e., stored back to the nonvolatile storage device) before the pages used by the read/write section can be discarded and reused.

At step 460, the program whose data has been loaded and whose read-only section (i.e., the bytecode data) has been memory mapped is initialized. However, when processing branches to the beginning of the program (i.e., the page/address where the program is supposed to reside), a page fault occurs because the page of the program has not yet been read from nonvolatile storage and loaded in memory 480 (see FIG. 2, location 250, and corresponding text for a description of the memory used to store the JXE file). The page fault results in the operating system's page fault handler 470 being invoked and loading the needed page(s). Page fault handler 470 reads the memory mapping data stored in mapping table 435 to determine where in the nonvolatile storage the requested page resides. The page fault handler reads the data from the nonvolatile storage locations and writes the data to the page addresses within memory 445 that have been allocated for the nonvolatile location.

At step 475, the code is executed. When an instruction is called that has not yet been loaded from nonvolatile storage 450, the page fault handler once again retrieves the needed pages by checking the page mappings and identifying the nonvolatile storage location that corresponds to the page address being called, reading the needed page(s) from nonvolatile storage, and writing the page(s) to the appropriate allocated address space in JXE memory space 480.

Throughout the execution of the program, operating system paging process 490 is able to select and discard previously loaded JXE pages. The discarded JXE pages are not written back to nonvolatile storage before being discarded because the paging process recognizes that the pages are already mapped read-only to a nonvolatile storage location. When discarded pages are once again needed, a page fault occurs and page fault handler 470 takes care of retrieving and loading the needed page(s) as described above.

FIG. 5 is a high level flowchart showing a virtual machine being initialized and executing programs, some of which are compiled using a Just-in-Time (JIT) compiler. The virtual machine processing commences at 500 whereupon, at step 510, the virtual machine, such as a Java Virtual Machine (JVM) is initialized.

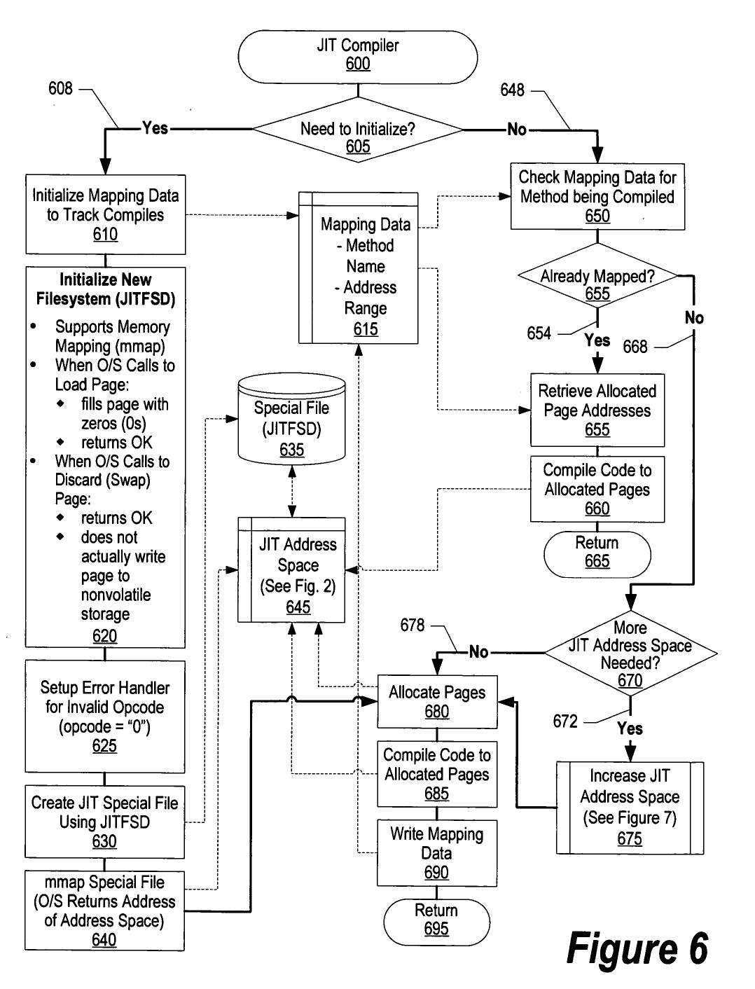

At step 520, programs (such as applets) that run within the virtual machine environment are executed. Some programs are interpreted using the virtual machine's interpreter. However, based on a variety of factors including program usage statistics, the virtual machine may decide to compile a program using a Just-In-Time (JIT) compiler (predefined process 530, see FIG. 6 and corresponding text for processing details). The compiled JIT program (JITed code 550) is stored in memory and memory mapped using a special JIT filesystem (JITFSD 540). During the compilation process, a mapping is maintained that maps the JITed code pages back to the method (i.e., the program name) that correspond to the JITed code. The mapping data is stored in mapping table 560.

The operating system is able to discard pages occupied by JITed code 550. Because the JITed code is memory mapped to a file using the special filesystem, the operating system instructs the special filesystem to write pages of JITed code that are about to be discarded to nonvolatile storage. The special filesystem does not write the pages to the nonvolatile storage, but informs the operating system that the pages were written successfully. When a branch is subsequently made to an address included in one of the discarded pages, a page fault occurs. The operating system responds by instructing the special filesystem to load the page(s). Because the special filesystem never actually swapped the pages in the first place, it does not have the data needed to load the pages. Instead, the special filesystem loads the memory pages with one or more occurrences of a special invalid operation code (opcode) and informs the operating system that the code was loaded successfully. Now, when the operating system attempts to branch to the code, an invalid operation exception occurs. The invalid operation exception is handled by error handler 570 which retrieves the name of the program (i.e., the method name) that corresponds to the faulting pages and either interprets the instructions or instructs the JIT compiler to recompile the program and store the program at the memory address that corresponds to the method in mapping data 560.

The virtual machine (or the entire computer system) is eventually shutdown. At this point, virtual machine processing ends at 595.

FIG. 6 is a flowchart showing steps taken by the JIT compiler when a Java program running by the Java Virtual Machine (JVM) is compiled. JIT compiler processing commences at 600 whereupon a determination is made as to whether the JIT compiler needs to be initialized (decision 605). If the JIT compiler needs to be initialized, decision 605 branches to “yes” branch 608 in order to initialize the JIT compiler.

Initialization of the JIT compiler begins at step 610 where mapping data structure 615, used to track JIT compilations, is initialized. At step 620, the special filesystem that is used for memory mapping JITed code is initialized. The special filesystem supports memory mapping (the mmap instruction). When the operating system instructs the special filesystem to load a page of data, the special filesystem fills all or a part of the page with an invalid operation code (opcode) and returns a successful completion code. In one embodiment, the special invalid opcode is x′00′. When the special filesystem is called upon to write one or more pages from memory back to nonvolatile storage, the special filesystem returns a successful completion code without actually writing the code to nonvolatile storage.

At step 625, an error handler is registered with the operating system to handle the invalid opcode (e.g., x′00′) that is written to pages loaded with the special filesystem. At step 630, a special file (file 635) is created using the special filesystem and, at step 640, the entire special file is memory mapped (mmap-ed) whereupon the operating system returns an address space (JIT address space 645, see FIG. 2, address space 230, and corresponding text for more details). The JIT compiler uses this address space for storing all JITed code resulting from the JIT compiler.

At step 680, the JIT compiler allocates pages within JIT address space 645 for storing the code resulting from compiling the code. At step 685, the JIT compiler compiles the code and writes the resulting compiled code to the allocated pages that reside within the JIT address space. At step 690, mapping data such as the program name (i.e., method name) and the address range are written to mapping data 615 and processing returns to the routine that called the JIT compiler at 695.

Returning to decision 605, if the JIT compiler has already been initialized, decision 605 branches to “no” branch 648 whereupon, at step 650, the mapping data is checked to determine whether the method being compiled was previously compiled. If the method was previously compiled and the pages storing the JITed code were reused by the operating system, then the method name and address range already exists in the mapping table. A determination is made as to whether the method is already mapped (decision 655). If the method is already mapped, decision 655 branches to “yes” branch 654 whereupon the previously allocated page addresses are retrieved (step 655) and the code is compiled to the allocated pages (step 660) before processing returns to the calling program (i.e., the error handler that called the JIT compiler when a page that used to store JITed code no longer the JITed code an, instead, contained an invalid opcode written to the page by the special filesystem) at 665.

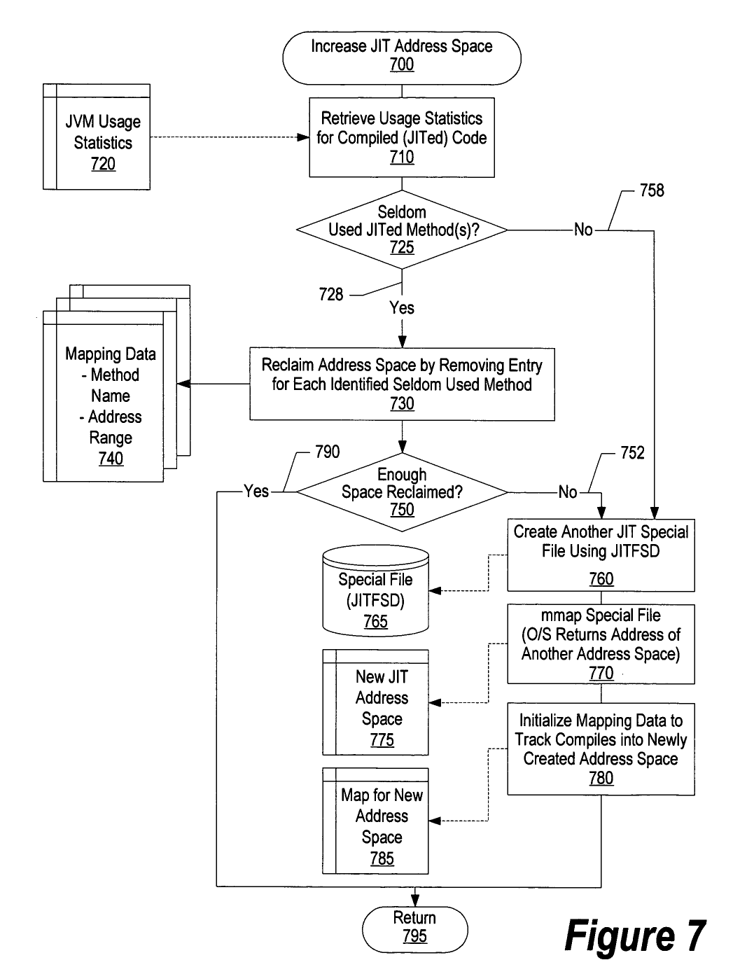

Returning to decision 655, if the method is not already mapped (i.e., the method has not previously been compiled), decision 655 branches to “no” branch 668 whereupon, another determination is made as to whether more JIT address space is needed in order to compile the requested method (decision 670). If additional JIT address space is needed, decision 670 branches to “yes” branch 672 whereupon the amount of JIT address space is increased (predefined process 675, see FIG. 7 and corresponding text for processing details). If additional JIT address space is not needed, decision 670 branches to “no” branch 678 bypassing predefined process 675.

As described above, steps 680 through 690 are performed in order to allocate pages from the JIT address space, compile the method to the allocated pages, and write mapping data to record the method name that was compiled and the address range within the JIT address space used by the JIT-compiled method. Processing then returns to the calling routine (i.e., the virtual machine) at 695.

FIG. 7 is a flowchart showing steps taken to increase the amount of address space used to store compiled programs resulting from the JIT compiler. The processing shown in FIG. 7 is called from predefined process 675 shown on FIG. 6. FIG. 7 processing commences at 700 whereupon, at step 710, usage statistics for JITed code are retrieved from usage statistics data store 720 maintained by the virtual machine (e.g., JVM).

A determination is made as to whether, based on the usage statistics, there are seldom used JITed methods that can be removed (decision 725). If there are seldom used JITed methods that can be removed, decision 725 branches to “yes” branch 728 whereupon, at step 730, the address space occupied by the seldom used methods is reclaimed by removing the entry for each seldom used method from mapping data tables 740. After the address space used by the seldom used methods has been reclaimed, a determination is made as to whether enough space has been reclaimed from the JITed code address space. If enough space has not been reclaimed, decision 750 branches to “no” branch 752 in order to allocate additional JITed code address space. On the other hand, if enough space has been reclaimed, decision 750 branches to “yes” branch 790 bypassing steps taken to allocate additional JITed code address space.

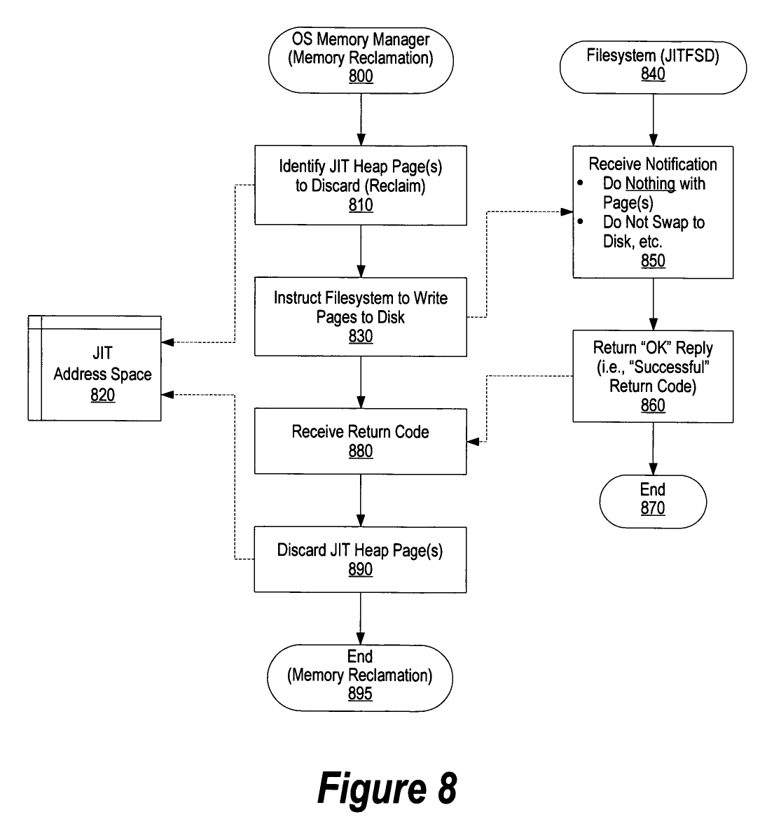

If either there were no seldom used JITed methods to remove (i.e., decision 725 branching to “no” branch 758) or enough address space for JITed code was not reclaimed by removing seldom used JITed code (i.e., decision 750 branching to “no” branch 752), then steps to provide additional address space for JITed code commence at step 760. At step 760, another JIT special file (file 765) is created using the special filesystem (JITFSD). At step 770, the special file that was created is memory mapped (mmap-ed), whereupon the operating system returns an address of address space 775 that is memory mapped to the newly created special file. At step 780, either a new map table 785 or the existing mapping table (see map 615 in FIG. 6) is initialized in order to inform the JIT compiler of the newly created JIT address space. The JIT compiler now manages the address space of the original JIT address space (see address space 645 in FIG. 6) as well as the newly created address space 775 to store compiled code resulting from the JIT compiler (JITed code). The space in both the original JIT address space and the newly created JIT address space can be reclaimed by the operating system when needed (see FIG. 8 for operating system memory reclamation details).

Processing thereafter returns to the calling program at 795. The calling routine being predefined process 675 shown in FIG. 6.

FIG. 8 is a flowchart showing the interaction between the operating system's memory manager (performing memory reclamation tasks) and a special filesystem that is used in conjunction with JITed code. The operating system, such as a Unix-based operating system, has a memory manager to manage memory. One aspect of memory management deals with reclaiming memory that is currently allocated for other processes. FIG. 8 shows how the memory reclamation routine of the operating system's memory manager identifies and reclaims memory currently being used to store JITed code.

Processing commences at 800 whereupon, at step 810, the operating system's memory manager identifies pages in the JIT memory area that to reclaim. One way in which the memory manager identifies pages to reclaim is by using a least recently used algorithm so that pages of memory that are not used as often are paged out before pages that are used more often. JITed address space 820 is the address space used by the JIT compiler to store compiled code resulting from the compiler (see FIG. 2, memory area 230, and corresponding text for further detail). These JITed pages are memory mapped to a file created using a special filesystem used for handling JIT compiled code pages (see FIGS. 5-7 and corresponding text for details regarding the creation of the JIT address space by memory mapping a file maintained by the special filesystem).

The operating system notes that pages within JIT address space 820 are memory mapped to a file maintained by the special filesystem using read-write memory mapping. Because read-write memory mapping was used to map the file, the operating system instructs the filesystem, in this case the special filesystem, to write the pages that are about to be discarded before the operating system's memory manager discards the pages. At step 830, the memory manager instructs the special filesystem to write the pages that are about to be discarded and reclaimed by the operating system to nonvolatile storage.

Special filesystem processing commences at 840 whereupon, at step 850, the special filesystem receives the request from the operating system. The special filesystem does not actually maintain a file in nonvolatile storage that includes the data from the JIT address space. Instead, the memory mapping was used so that the operating system interfaces with the special filesystem to handle page faults and other file actions pertaining to the JIT address space. The special filesystem, therefore, does not do anything with the pages in response to the request and does not write any of the data to disk. However, the special filesystem, at step 860, returns a response to the operating system indicating that the pages were successfully written to nonvolatile storage, clearing the way for the operating system to discard the pages and reuse the memory space. Special filesystem processing of the “write” request then ends at 870.

Returning to operating system processing, at step 880, the operating system's memory manager receives the completion code from the special filesystem indicating that the pages were successfully written to nonvolatile storage. In response to receiving the successful completion response, at step 890, the memory manager discards the identified pages from the JIT address space and is able to reuse the memory for another application. Operating system memory reclamation processing thereafter ends at 895.

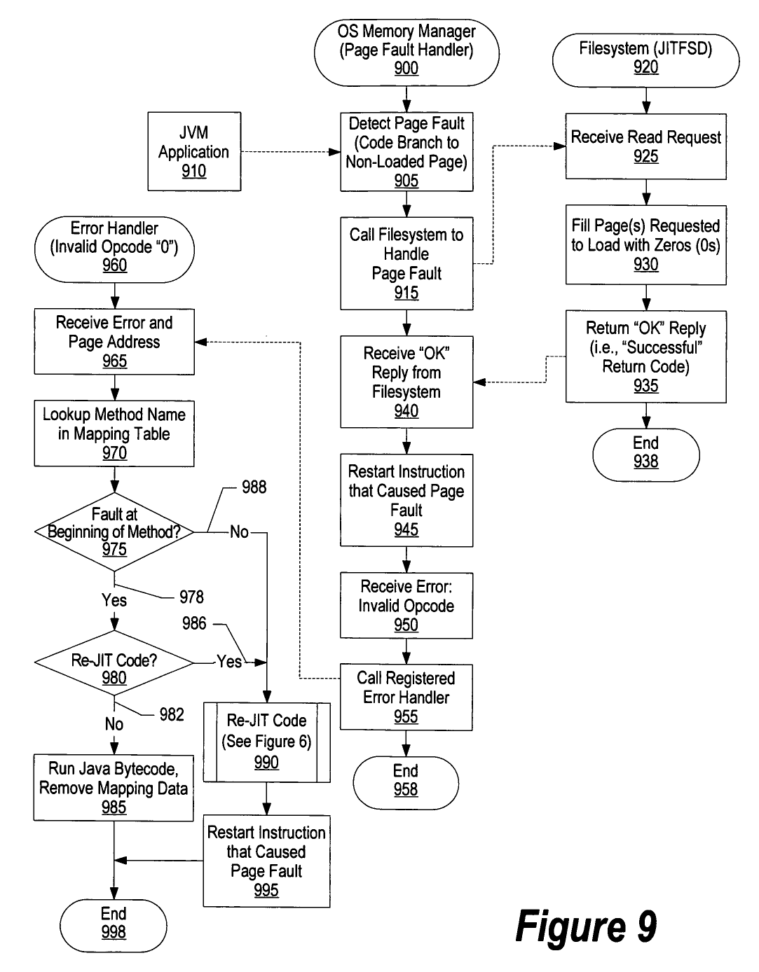

FIG. 9 is a flowchart showing interaction between the operating system's memory manager (performing page fault handling), the special filesystem that is used in conjunction with JITed code, and an error handler that is used to reload code that was removed from memory during a prior memory reclamation task. After a page containing JITed code has been reclaimed by the operating system's memory manager (see FIG. 8 for details), the code that used to reside in the discarded pages can still be called (i.e., branched to) by another process or code instruction that is currently being executed, such as JVM method 910. When a branch is made to an address within a discarded page, a page fault results. The operating system's page fault handler commences at 900, whereupon at step 905, the page fault is detected.

At step 915, the page fault handler calls the special filesystem and instructs the special filesystem to load the pages. Special filesystem processing of the load request commences at 920 whereupon, at step 925, the special filesystem receives the load request from the page fault handler. The request includes the address of the page or pages that the page fault handler needs to have loaded by the special filesystem. Because the special filesystem did not write the code to nonvolatile storage when the memory manager discarded the pages (see FIG. 8 and corresponding text for details), the special filesystem does not have the data needed to load the pages. Instead, at step 930, the special filesystem writes an invalid operation code (opcode), or a series of the same invalid opcode, to the page or pages that the page fault handler is requesting to have loaded. After writing the invalid opcode to the page(s), at step 935, the special filesystem replies with returns with a successful completion code indicating that the page(s) were successfully loaded. Special filesystem processing of the load request thereafter ends at 938.

Returning to the page fault handler, at step 940 the page fault handler receives the response from the special filesystem indicating that page(s) were successfully loaded (even though the page(s) were not actually loaded and an invalid opcode was actually written to the page(s)). At step 945, the operating system attempts to restart the instruction that caused the page fault to occur. This time, however, the page contains an invalid opcode which results in an invalid operation exception that occurs in response to restarting the instruction and is detected at step 950. When the JIT compiler was initialized, an error handler was registered with the operating system to handle the invalid opcode (see FIG. 6, step 625, and corresponding text for details regarding the initialization of the error handler). At step 955, the operating system calls the registered error handler in order to handle the invalid opcode. Processing of the page fault handler thereafter ends at 958.

Error handler processing commences at 960 whereupon, at step 965, the error handler receives the error and the page address where the error occurred. At step 970, the error handler retrieves the method name that corresponds to the page address from the mapping data table(s). A determination is made, at decision 975 as to whether the page fault occurred at the beginning of the method (i.e., the fault address being the same as the starting address for the method). If the fault occurred at the beginning of the method, decision 975 branches to “yes” branch 978 whereupon the virtual machine can determine whether to recompile the code using the JIT compiler or interpret the code (decision 980). For example, the code may have been extensively used during shortly after the virtual machine was initialized, but hardly used thereafter. Using this example, the virtual machine may decide to interpret the code instead of re-compiling it. If the virtual machine decides not to recompile the code, decision 980 branches to “no” branch 982 whereupon, at step 985, the interpretable version of the code is executed using the virtual machine's interpreter and the mapping data corresponding to the method is removed to indicate that a JIT compiled version of the code is no longer being maintained in the JIT address space.

If either (1) the faulting address was not at the beginning of the method (i.e., decision 975 branching to “no” branch 988), or (2) the virtual machine decided to recompile the code even though the fault occurred at the beginning of the method (i.e., decision 980 branching to “yes” branch 986), then the method is recompiled using the JIT compiler (predefined process 990, see FIG. 6 steps 655-665 and corresponding text for processing details). When the code has been recompiled, at step 995, the instruction that caused the page fault is restarted. This time, because the code was recompiled into the same address space, the address contains a valid instruction allowing the compiled method to restarted.

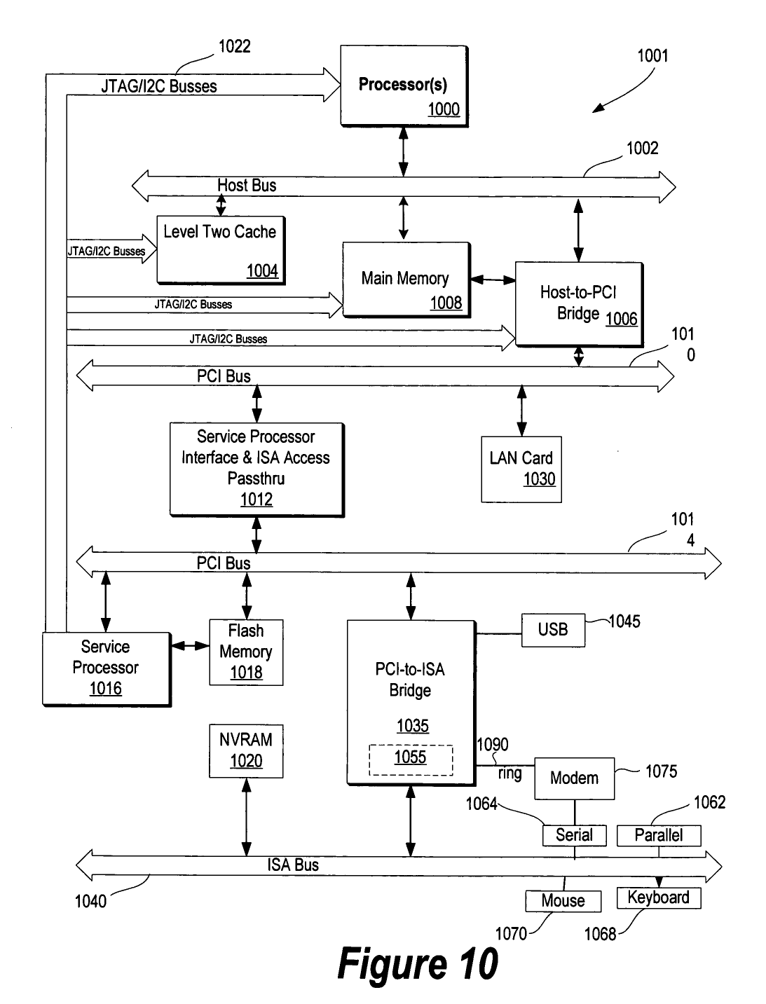

FIG. 10 illustrates information handling system 1001 which is a simplified example of a computer system capable of performing the computing operations described herein. Computer system 1001 includes processor 1000 which is coupled to host bus 1002. A level two (L2) cache memory 1004 is also coupled to host bus 1002. Host-to-PCI bridge 1006 is coupled to main memory 1008, includes cache memory and main memory control functions, and provides bus control to handle transfers among PCI bus 1010, processor 1000, L2 cache 1004, main memory 1008, and host bus 1002. Main memory 1008 is coupled to Host-to-PCI bridge 1006 as well as host bus 1002. Devices used solely by host processor(s) 1000, such as LAN card 1030, are coupled to PCI bus 1010. Service Processor Interface and ISA Access Pass-through 1012 provides an interface between PCI bus 1010 and PCI bus 1014. In this manner, PCI bus 1014 is insulated from PCI bus 1010. Devices, such as flash memory 1018, are coupled to PCI bus 1014. In one implementation, flash memory 1018 includes BIOS code that incorporates the necessary processor executable code for a variety of low-level system functions and system boot functions.

PCI bus 1014 provides an interface for a variety of devices that are shared by host processor(s) 1000 and Service Processor 1016 including, for example, flash memory 1018. PCI-to-ISA bridge 1035 provides bus control to handle transfers between PCI bus 1014 and ISA bus 1040, universal serial bus (USB) functionality 1045, power management functionality 1055, and can include other functional elements not shown, such as a real-time clock (RTC), DMA control, interrupt support, and system management bus support. Nonvolatile RAM 1020 is attached to ISA Bus 1040. PCI-to-SCSI bridge 1080 provides bus control to handle transfers between PCI bus 1014 and SCSI bus 1085. SCSI device 1090 (i.e. a SCSI hard drive) communicates with other parts of computer system 1001 using SCSI bus 1085.

Service Processor 1016 includes JTAG and I2C busses 1022 for communication with processor(s) 1000 during initialization steps. JTAG/I2C busses 1022 are also coupled to L2 cache 1004, Host-to-PCI bridge 1006, and main memory 1008 providing a communications path between the processor, the Service Processor, the L2 cache, the Host-to-PCI bridge, and the main memory. Service Processor 1016 also has access to system power resources for powering down information handling device 1001.

Peripheral devices and input/output (I/O) devices can be attached to various interfaces (e.g., parallel interface 1062, serial interface 1064, keyboard interface 1068, and mouse interface 1070 coupled to ISA bus 1040. Alternatively, many I/O devices can be accommodated by a super I/O controller (not shown) attached to ISA bus 1040.

In order to attach computer system 1001 to another computer system to copy files over a network, LAN card 1030 is coupled to PCI bus 1010. Similarly, to connect computer system 1001 to an ISP to connect to the Internet using a telephone line connection, modem 1075 is connected to serial port 1064 and PCI-to-ISA Bridge 1035.

While the computer system described in FIG. 10 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A computer implemented method of reclaiming memory occupied by Just-in-Time (JIT) compiled programs, said method comprising:
tracking a JIT compiled program, the tracking recording tracking data that includes a method name corresponding to the JIT compiled program and an address range that corresponds to the JIT compiled program;
discarding one or more memory pages included in the address range;
branching to an address included in one of the discarded pages, the branching resulting in a page fault;
retrieving the method name corresponding to the address that resulted in the page fault; and
executing a method corresponding to the retrieved method name.

2. The method of claim 1 wherein executing the method further comprises:
recompiling the method using a JIT compiler, the recompiling resulting in a replacement JIT compiled program stored at the recorded address range, wherein the executed method is the replacement JIT compiled program.

3. The method of claim 1 wherein executing the method further comprises:
removing the method name and the corresponding address range from the tracking data;
retrieving an interpretable form of the method; and
interpreting code included in the interpretable form of the method.

4. The method of claim 1 further comprising:
memory mapping the JIT compiled program from a nonvolatile storage location to the address range using a special filesystem;
prior to the discarding, receiving, at the special filesystem, an instruction to write (to nonvolatile storage) the one or more memory pages that are about to be discarded; and
returning a response indicating successful completion of the instruction without writing any of the pages to the nonvolatile storage location.

5. The method of claim 4 further comprising:
registering an error handler to handle a specific invalid operation code (opcode) prior to discarding any of the memory pages;
in response to the page fault, calling the special filesystem to load the one or more discarded memory pages from the nonvolatile storage location;
writing, by the special filesystem, one or more occurrences of the invalid opcode to one or more of the memory pages that were previously discarded; and
re-branching to the address that caused the page fault, the re-branching resulting in an invalid opcode exception.

6. The method of claim 5 further comprising:
executing the error handler in response to encountering the invalid opcode, wherein the executing includes:
retrieving the address range from the tracking data that includes the address that caused the page fault;
retrieving the method name from the tracking data, wherein the retrieved method name corresponds to the address range; and
re-compiling method code corresponding to the method name so that the re-compiled program is stored at the same address range as the original JIT compiled program.

7. The method of claim 6 further comprising:
branching a third time to the address that caused the page fault, the branching performed after the re-compiling; and
executing the re-compiled method code.

8. An information handling system comprising:
one or more processors;
a memory accessible by the processors;
a nonvolatile storage device accessible by the processors;
a virtual machine that includes a Just-in-Time (JIT) compiler loaded from the nonvolatile storage device to the memory and executed by the processors;
a memory reclamation tool for reclaiming memory occupied by JIT compiled programs, the memory reclamation tool including software code effective to:
track a JIT compiled program, the tracking including software code effective to record tracking data that includes a method name corresponding to the JIT compiled program and an address range that corresponds to the JIT compiled program;
discard one or more memory pages included in the address range;
branch to an address included in one of the discarded pages resulting in a page fault;
retrieve, from the tracking data, the method name corresponding to the address that resulted in the page fault; and
execute a method corresponding to the retrieved method name.

9. The information handling system of claim 8 wherein the software code effective to execute the method further comprises software code effective to:
recompile the method using the JIT compiler, the recompiling resulting in a replacement JIT compiled program stored at the recorded address range, wherein the executed method is the replacement JIT compiled program.

10. The information handling system of claim 8 wherein the software code effective to execute the method further comprises software code effective to:
remove the method name and the corresponding address range from the tracking data;
retrieve an interpretable form of the method; and
interpret code included in the interpretable form of the method.

11. The information handling system of claim 8 further comprising software code effective to:
memory map the JIT compiled program from a nonvolatile storage location to the address range using a special filesystem;
prior to the discarding, receive, at the special filesystem, an instruction to write (to the nonvolatile storage device) the one or more memory pages that are about to be discarded; and
return a response indicating successful completion of the instruction without writing any of the pages to the nonvolatile storage location.

12. The information handling system of claim 11 further comprising software code effective to:
register an error handler to handle a specific invalid operation code (opcode) prior to discarding any of the memory pages;
in response to the page fault, call the special filesystem to load the one or more discarded memory pages from the nonvolatile storage location;
write, by the special filesystem, one or more occurrences of the invalid opcode to one or more of the memory pages that were previously discarded; and
re-branch to the address that caused the page fault, the re-branch resulting in an invalid opcode exception.

13. The information handling system of claim 12 further comprising software code effective to:
execute the error handler in response to encountering the invalid opcode, wherein the execution of the error handler includes software code effective to:
retrieve the address range from the tracking data that includes the address that caused the page fault;
retrieve the method name from the tracking data, wherein the retrieved method name corresponds to the address range;
re-compile method code corresponding to the method name so that the re-compiled program is stored at the same address range as the original JIT compiled program;
branch a third time to the address that caused the page fault, the branching performed after the re-compiling; and
execute the re-compiled method code.

14. A computer program product stored on a computer operable media for reclaiming memory occupied by Just-in-Time (JIT) compiled programs, said computer program product comprising:
means for tracking a JIT compiled program, the tracking recording tracking data that includes a method name corresponding to the JIT compiled program and an address range that corresponds to the JIT compiled program;
means for discarding one or more memory pages included in the address range;
means for branching to an address included in one of the discarded pages, the branching resulting in a page fault;
means for retrieving the method name corresponding to the address that resulted in the page fault; and
means for executing a method corresponding to the retrieved method name.

15. The computer program product of claim 1 wherein the means for executing the method further comprises:
means for recompiling the method using a JIT compiler, the recompiling resulting in a replacement JIT compiled program stored at recorded address range, wherein the executed method is the replacement JIT compiled program.

16. The computer program product of claim 1 wherein the means for executing the method further comprises:
means for removing the method name and the corresponding address range from the tracking data;
means for retrieving an interpretable form of the method; and
means for interpreting code included in the interpretable form of the method.

17. The computer program product of claim 1 further comprising:
means for memory mapping the JIT compiled program from a nonvolatile storage location to the address range using a special filesystem;
prior to the discarding, means for receiving, at the special filesystem, an instruction to write (to nonvolatile storage) the one or more memory pages that are about to be discarded; and
means for returning a response indicating successful completion of the instruction without writing any of the pages to the nonvolatile storage location.

18. The computer program product of claim 17 further comprising:
means for registering an error handler to handle a specific invalid operation code (opcode) prior to discarding any of the memory pages;
in response to the page fault, means for calling the special filesystem to load the one or more discarded memory pages from the nonvolatile storage location;
means for writing, by the special filesystem, one or more occurrences of the invalid opcode to the memory pages that were previously discarded; and
means for re-branching to the address that caused the page fault, the re-branching resulting in an invalid opcode exception.

19. The computer program product of claim 18 further comprising:
means for executing the error handler in response to encountering the invalid opcode, wherein the means for executing includes:
means for retrieving the address range from the tracking data that includes the address that caused the page fault;
means for retrieving the method name from the tracking data, wherein the retrieved method name corresponds to the address range; and
means for re-compiling method code corresponding to the method name so that the re-compiled program is stored at the same address range as the original JIT compiled program.

20. The computer program product of claim 19 further comprising:
means for branching a third time to the address that caused the page fault, the branching performed after performing the means for re-compiling; and
means for executing the re-compiled method code.
